(19) United States
(12) Patent Application Publication
(10) Pub. No.: US 2008/0134520 A1
(43) Pub. Date: Jun. 12, 2008

(54) UTENSIL WITH INTEGRATED FIGURINE AND SOUND

(76) Inventor: Sagi Kormandel, Sherman Oaks, CA (US)

Correspondence Address: Steve Zellers, 12 Ebony Glade, Laguna Niguel, CA, 92677, US

(21) Appl. No.: 11/952,294

(22) Filed: Dec. 7, 2007

Related U.S. Application Data
(60) Provisional application No. 60/869,312, filed on Dec. 8, 2006.

(51) Int. Cl. B26B 11/00

(52) U.S. Cl. 30/142; 30/123

(57) ABSTRACT

A utensil in accordance with one embodiment comprising a handle; a serving portion coupled to the handle; a figurine coupled to the handle; and sound generation circuitry at least partially encapsulated in the handle or the figurine, wherein the sound generation circuitry outputs sound corresponding to the figurine. An apparatus in accordance with one embodiment for feeding a person comprising a utensil; a figurine coupled to the utensil; and sound generation circuitry coupled to the utensil, wherein the sound generation circuit outputs sound corresponding to the figurine. The utensil in various embodiments is a spoon, a fork, a knife or a spork. The figurine in various embodiments is an animal, a vehicle, or a cartoon character.

### BACKGROUND OF THE INVENTION

1. Field of the Invention

The present invention relates to utensils. More specifically, the present invention relates to utensils used to feed people and more specifically children.

2. Discussion of the Related Art

Children have been fed by their parents, grandparents and friends for centuries. Many times the person feeding the child will try to play games or make noises to get the child to eat more food and be more interested in the entire process. Furthermore, colored utensils (e.g., spoons) that are small and made from plastic or some other synthetic material are specially designed for children are used to make the process more enjoyable for both the person feeding the child and for the child. However, sometimes the child will still not be interested in eating. Thus, there is still room for improvement in the design of such utensils that will more fully captivate the child and make eating a more enjoyable and fun time for both the parent and child.

### SUMMARY OF THE INVENTION

The embodiments here provide an improved utensil for feeding children. Some embodiments of the utensil include a figurine wherein the utensil can output sound corresponding to the figurine.

One embodiment can be characterized as a utensil comprising a handle; a serving portion coupled to the handle; a figurine coupled to the handle; and sound generation circuitry at least partially encapsulated in the handle or the figurine, wherein the sound generation circuitry outputs sound corresponding to the figurine. In some embodiments, the utensil is a spoon, a fork, a knife or a spork. In some embodiments, the figurine is an animal, a vehicle, or a cartoon character.

Another embodiment can be characterized as an apparatus for feeding a person comprising a utensil; a figurine coupled to the utensil; and sound generation circuitry coupled to the utensil, wherein the sound generation circuit outputs sound corresponding to the figurine. In some embodiments, the utensil is a spoon, a fork, a knife or a spork. In some embodiments, the figurine is an animal, a vehicle, or a cartoon character.

Yet another embodiment can be characterized as a utensil comprising a serving portion; a figurine coupled to serving portion; and sound generation circuitry at least partially encapsulated in the figurine, wherein the sound generation circuitry outputs sound corresponding to the figurine.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a diagram illustrating a utensil with a figurine of a dog coupled to a handle of the utensil in accordance with one embodiment;

FIG. 2 is a diagram illustrating a utensil with a figurine of a cat coupled to a handle of the utensil in accordance with one embodiment;

FIG. 3 is a diagram illustrating a utensil with a figurine of a pig coupled to a handle of the utensil in accordance with one embodiment;

FIG. 4 is a diagram illustrating a utensil with a figurine of a cow coupled to a handle of the utensil in accordance with one embodiment;

FIG. 5 is a diagram illustrating a utensil with a figurine of a chicken coupled to a handle of the utensil in accordance with one embodiment;

FIG. 6 is a diagram illustrating a utensil with a figurine of a plane coupled to a handle of the utensil in accordance with one embodiment;

FIG. 7 is a diagram illustrating a utensil with a figurine of a boat coupled to a handle of the utensil in accordance with one embodiment;

FIG. 8 is a diagram illustrating a utensil with a figurine of a fire engine coupled to a handle of the utensil in accordance with one embodiment;

FIG. 9 is a diagram illustrating a utensil with a figurine of a tractor coupled to a handle of the utensil in accordance with one embodiment;

FIG. 10 is a diagram illustrating a utensil with a figurine of a train coupled to a handle of the utensil in accordance with one embodiment;

FIG. 11 is a diagram illustrating a utensil with a figurine of a lion coupled to a handle of the utensil in accordance with one embodiment;

FIG. 12 is a diagram illustrating a utensil with a figurine of a monkey coupled to a handle of the utensil in accordance with one embodiment;

FIG. 13 is a diagram illustrating a utensil with a figurine of a zebra train coupled to a handle of the utensil in accordance with one embodiment;

FIG. 14 is a diagram illustrating a utensil with a figurine of a parrot coupled to a handle of the utensil in accordance with one embodiment;

FIG. 15 is a diagram illustrating a utensil with a figurine of an elephant coupled to a handle of the utensil in accordance with one embodiment;

FIG. 16 is a block diagram illustrating a sound generation circuit in accordance with one embodiment;

FIG. 17 is a diagram illustrating a utensil integrated with a figurine of a plane in accordance with one embodiment;

FIG. 18 is a diagram illustrating a utensil integrated with a figurine of a fire truck in accordance with one embodiment;

FIG. 19 is a diagram illustrating a utensil integrated with a figurine of a tractor in accordance with one embodiment;

FIG. 20 is a diagram illustrating a utensil integrated with a figurine of a train in accordance with one embodiment; and

FIG. 21 is a diagram illustrating a utensil integrated with a figurine of a boat in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

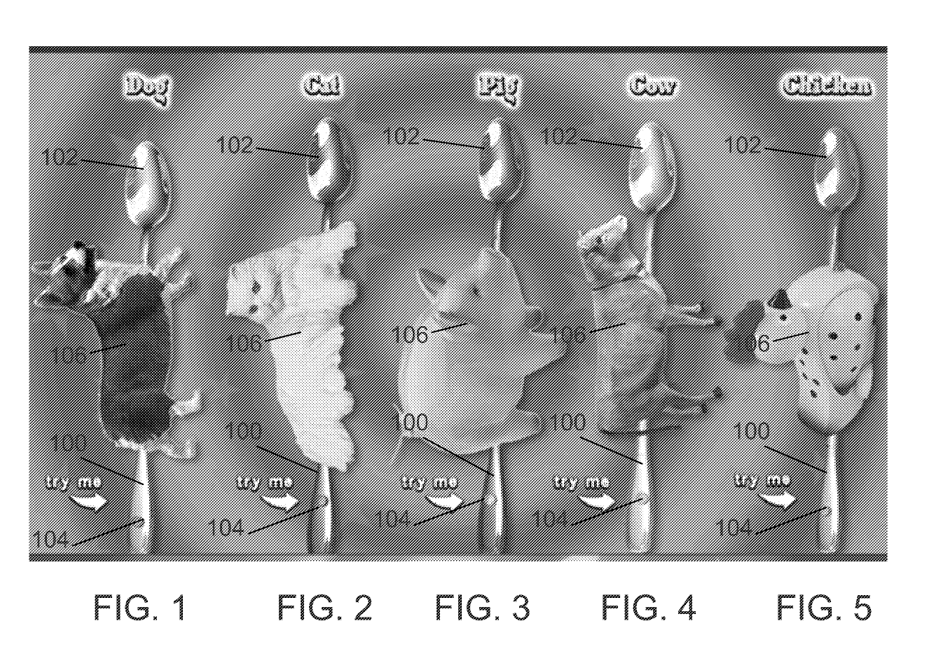

Referring to FIG. 1 a diagram is shown illustrating a utensil with a figurine of a dog coupled to a handle of the utensil in accordance with one embodiment. Shown is a handle 100, a serving member 102, a button 104 and a figurine 106.

The figurine, in accordance with one embodiment, is a dog. The figurine 106 is coupled to the handle 100 and can be attached to the handle 100 or formed integrally therewith. The handle 100 is also coupled to the serving member 102 either directly or through the figurine 106. The serving member 102, in the example shown, is a bowl shaped portion of the utensil. The serving member 102 can be many different sizes and shapes and can be shaped to form the serving portion of a fork, a spoon, a knife or a spork. When feeding children, generally a spoon is utilized, however, the utensil may also be a fork, knife, spork (i.e., a combined fork and spoon) or other type of apparatus that is used for serving or eating food or liquids. The button 104 is also coupled to the handle. The button 104 can be attached directly to the handle 100 or can be formed as part of the figurine 106 and thus, be coupled to the handle 100 through the figurine 106.

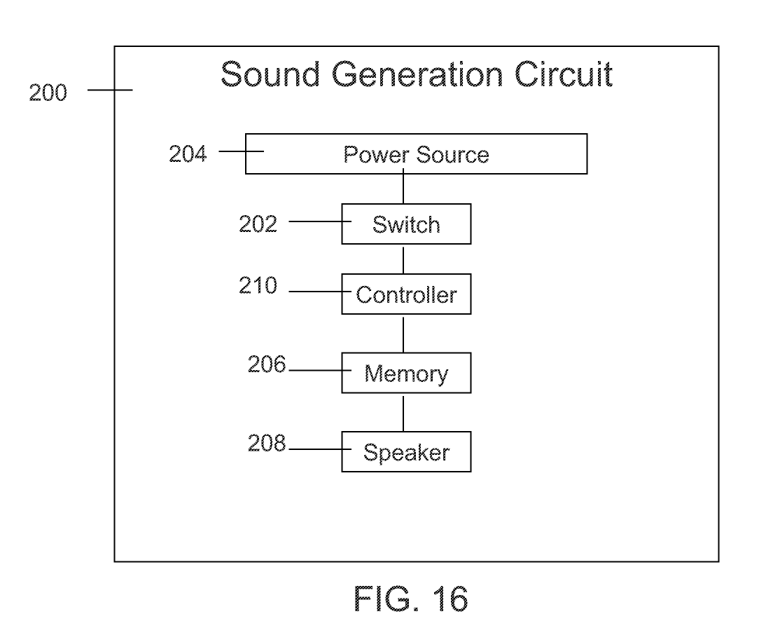

In operation, when the button 104 is pushed, the utensil will output (e.g., emit or play) sound that corresponds to the figurine 106. For example, in the embodiment shown in FIG. 1, the figurine 106 is a dog. Thus, when the button 104 is pressed, the utensil will emit a sound that corresponds to the sound a dog would normally make. Thus, the utensil can emit a barking sound, a whimpering sound or any other sound that is associated generally associated with a dog. In one example, every time the button 104 is pressed, a barking sound would be emitted or played. Alternatively, the sound that is emitted or played by the utensil can be alternated between two or more different sounds each time the button 104 is pressed. That is, for example, the first time the button 104 is pressed a barking sound will be played and the second time the button 104 is pressed a whimpering sound will be played or a different barking sound will be played. The third time the button 104 is pressed the barking sound will be played again. The sounds can either be played in a predetermined order or can be played randomly. For example, if the utensil can play two or more sounds, each time the button is pressed, the utensil will randomly select one of the sounds and play it. Sound generation circuitry in accordance with one embodiment will be described below with reference to FIG. 16.

The utensil incorporating the figurine of the dog is used when feeding small children. For example, as a parent is feeding the child, instead of imitating a train noise or other noise, the parent can press the button and move the utensil toward the child's mouth. The sound being emitted from the utensil will keep the child entertained and interested in eating. Advantageously, this can make feeding and eating more enjoyable for both the parents and the child.

Referring next to FIGS. 2-15, illustrated are utensils with various figurines coupled to a handle of the utensils in accordance with different embodiments. Each of the embodiments shown illustrate different figurines that can be incorporated into the utensil. It should be understood that the various figurines are only exemplary and figurines illustrating other animals, vehicles, or devices can be incorporated into the utensil. The figurines can represent real animals and vehicles or can represent, for example, cartoon figures (e.g., Disney characters), science fiction characters, spaceships, or other characters or imaginary devices.

The utensils shown in FIGS. 2-15 operate in the same manner as the utensil described above with reference to FIG. 1. Each of the utensils shown in FIGS. 2-15 will play one or more sounds that correspond to the figurine that is coupled to the handle. For example, the embodiment shown in FIG. 8, a fire engine is coupled to (e.g., attached to or formed integrally therewith) the handle of the utensil. The utensil can play one or more sounds that correspond to a fire engine. For example, the sounds can include a siren, an engine sound, and/or a honking sound. Thus, when the button is pressed, one or more of the sounds is played. All of the other utensils operate in the same manner.

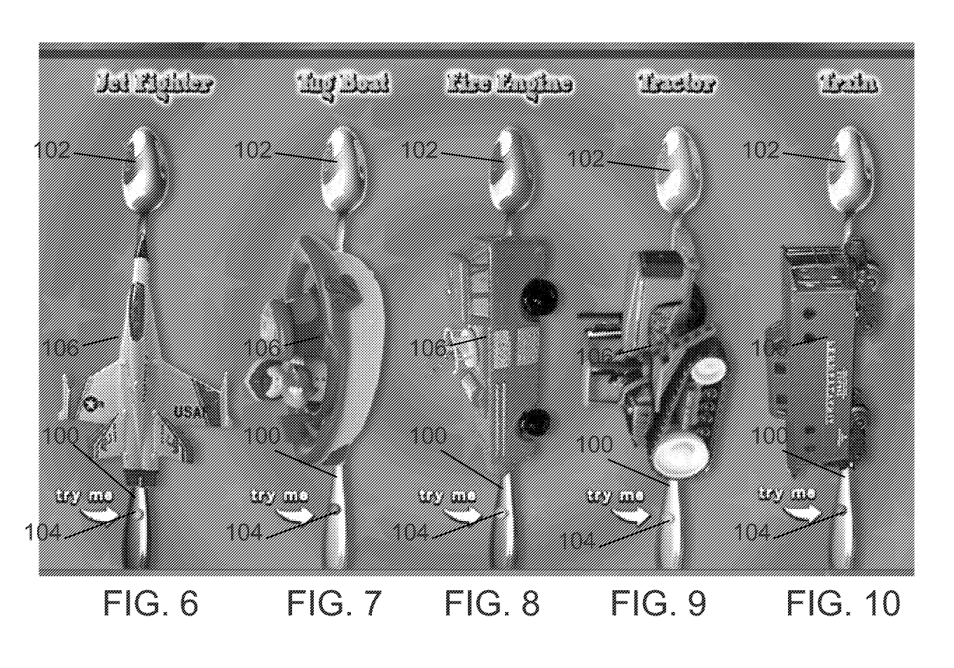

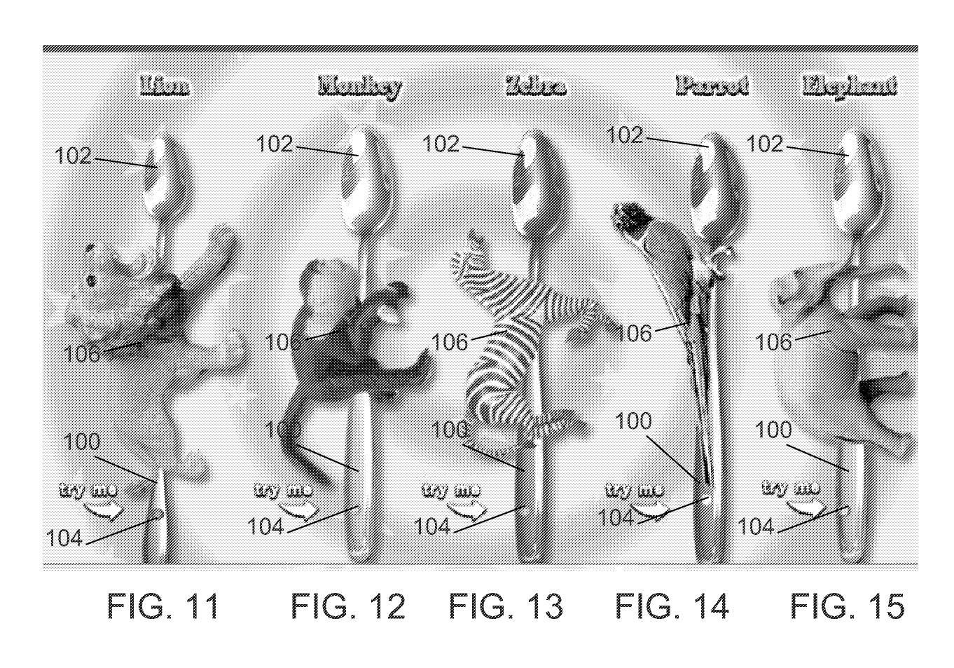

The utensils can be sold individually or can be sold as a set. For example, the utensils shown in FIGS. 1-5 can be sold as set with an animal theme. The utensils shown in FIGS. 6-10 can be sold as set with a vehicle theme and the utensils shown in FIGS. 11-15 can be sold as a set with a jungle theme.

The utensils are made from plastic in accordance with one embodiment, however, other materials can be used to make all or portions of the utensils. For example, all or a portion of the utensils can be made using a composite material, rubber, metal, or many other type of material that is known in the art. The utensils can be manufactured using an injection molding or any other type of manufacturing technique, such as is known in the art.

Referring next to FIG. 16 a block diagram is shown illustrating sound generation circuitry in accordance with one embodiment. Shown is the sound generation circuitry 200, a switch 202, a power source 204, a memory 206, a speaker 208 and a controller 210. The diagram as shown is a meant to represent the functionality of the sound generation circuitry 200 and is not necessarily indicative of the interconnections between various components in the sound generation circuitry that would be present in one embodiment of a commercially implemented circuit. It is well within the skill of one of ordinary skill in the art to design and implement a sound generation circuit in many different ways.

The sound generation circuitry 200 is mounted within the handle 100 and/or the figurine 106 of the utensil in accordance with one embodiment. The sound generation circuitry 200 shown is capable of playing a sound that corresponds to the figurine 106. It should be understood that there are many different ways to implement the sound generation circuitry 200 and that the embodiment shown should only be considered as one exemplary implementation. As described herein, circuitry can refer to hardware, firmware, or software or any combination thereof and can be implemented on one or more discrete or integrated electronic components. In one embodiment, an audio integrated circuit (IC) is utilized to implement all or a portion of the sound generation circuitry 200.

The switch 202 is coupled to the controller 210. Upon activation of the switch (e.g., by pressing the button), the controller 210 will access audio data stored in the memory 206 which will be output through the speaker 208. The button 104 is one example of a switch activator. The switch activator can be implemented as a button, a switch, a touch sensor, or other type of switch activator such as is known in the art. In one embodiment, the switch activator can be activated by the movement of the utensil. It should be understood that the memory 206, the controller 210, and the switch 202 can be implemented in one or more discrete or integrated circuits.

The memory 206 stores audio data that corresponds to the figurine. The memory 206 can store one or audio files that correspond to the figurine. The memory 206 is, for example, a static or dynamic memory such as a flash memory, RAM, ROM, volatile, or non-volatile memory. Preferably, the memory 206 is a non-volatile memory such that the power source 204 only needs to be utilized upon activation of the switch. The power source 204 is, for example, a battery. The power source 204 can optionally be replaceable.

Again, it should be reiterated that the audio generation circuitry is one exemplary embodiment and that the blocks shown are only one optional configuration. Additionally, each of the blocks does not necessarily represent a physical component, but can also be thought of as a functional module that can be implemented as a hard wired circuitry or with one or more discrete or integrated components. Preferably, the sound generation circuitry 200 is partially or entirely encapsulated in the handle or figurine. Additionally, it is preferred that the sound generation circuitry 200 is implemented such that the utensil can be washed without water or moisture contacting the sound generation circuitry 200.

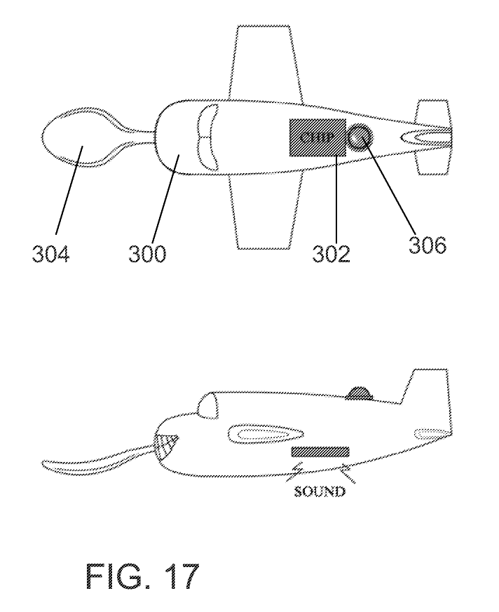

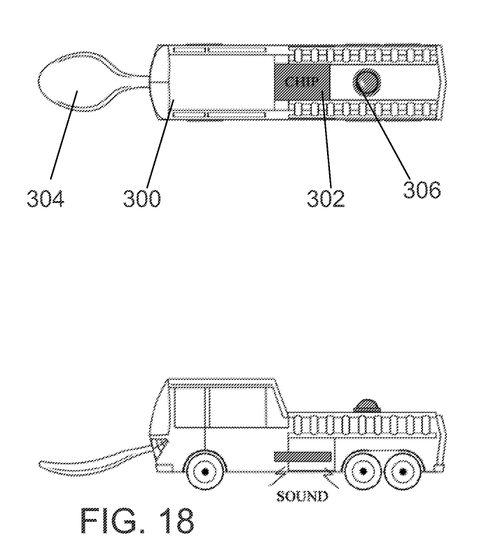

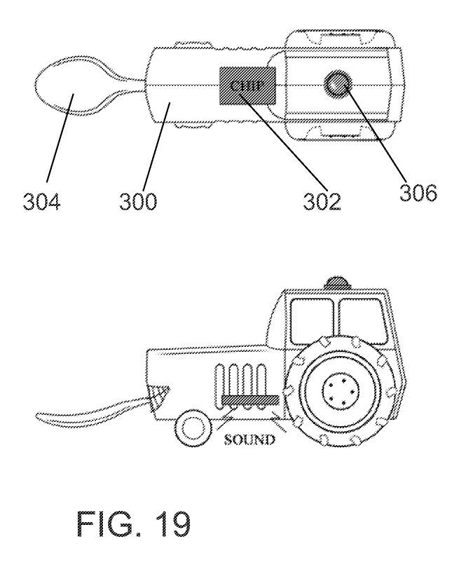

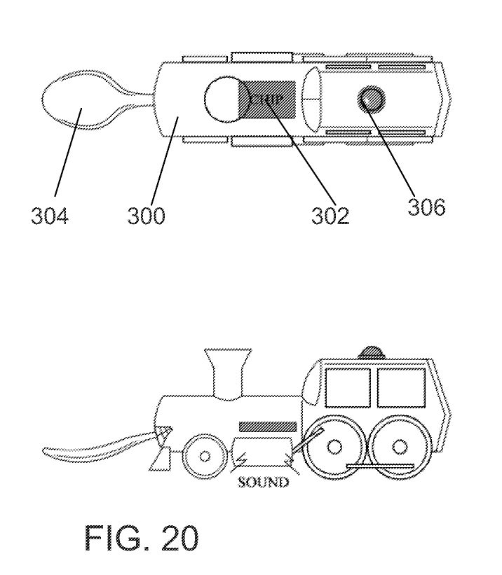

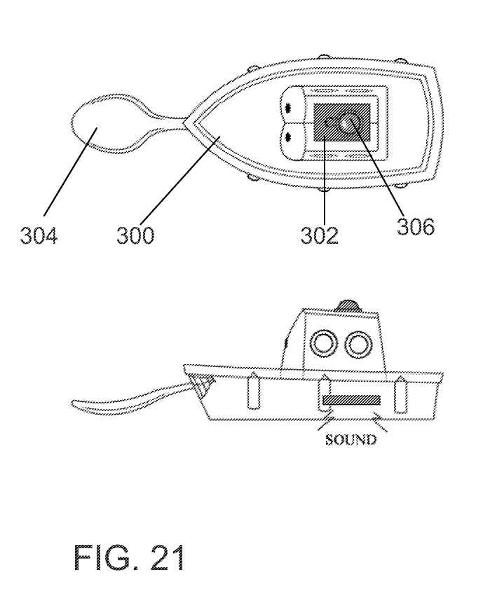

Referring to FIGS. 17-21, shown are utensils integrated with a figurine in accordance with various embodiments. Shown is a figurine 300, sound generation circuitry 302, a serving member 304, and a button 306.

The utensils shown in FIGS. 17-21 operate in the same manner as the utensil described above with reference to FIG. 1. Each of the utensils shown in FIGS. 17-21 will play one or more sounds that correspond to the figurine. However, the utensils shown in FIGS. 17-21 each have a figurine 300 that acts as the handle for the utensil. As described herein, this configuration is also considered to be a figurine 300 that is coupled to the handle of the utensil. The handle is simply acting as part of the figurine 300 that is integrated with the utensil. As shown, each figuring includes a sound chip or sound generation circuitry 302 that is enclosed (at least partially) by the figurine 300. In this embodiment the button 306, switch or other sound activation mechanism is coupled to the figurine.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

I claim:

1. A utensil comprising:
a handle;
a serving portion coupled to the handle;
a figurine coupled to the handle; and
sound generation circuitry at least partially encapsulated in the handle or the figurine, wherein the sound generation circuitry outputs sound corresponding to the figurine.

2. The utensil of claim 1 wherein the utensil comprises a spoon, a fork, a knife or a spork.

3. The utensil of claim 1 further comprising a switch activator coupled to the handle or the figurine, wherein the sound generation circuitry outputs the sound corresponding to the figurine upon activation of the switch activator.

4. The utensil of claim 1 further comprising a power source coupled to the sound generation circuitry.

5. The utensil of claim 1 wherein the sound generation circuitry includes:
a memory;
a speaker coupled to the memory;
a switch; and
control circuitry coupled to the switch and the memory.

6. The utensil of claim 5 wherein a switch activator is coupled to the switch.

7. The utensil of claim 6 wherein the switch activator is a button coupled to the handle.

8. The utensil of claim 7 wherein the memory is a non-volatile memory.

9. The utensil of claim 1 wherein the figurine is an animal, a vehicle, or a cartoon character.

10. The utensil of claim 1 wherein the sound generation circuitry outputs two or more different sounds that correspond to the figurine.

11. A apparatus for feeding a person comprising:
a utensil;
a figurine coupled to the utensil; and
sound generation circuitry coupled to the utensil, wherein the sound generation circuit outputs sound corresponding to the figurine.

12. The apparatus of claim 11 wherein the figurine is formed integrally with the utensil.

13. The apparatus of claim 11 wherein the utensil comprises a spoon, a fork, a knife or a spork.

14. The apparatus of claim 11 further comprising a switch activator coupled to utensil, wherein the sound generation circuitry outputs the sound corresponding to the figurine upon activation of the switch activator.

15. The apparatus of claim 11 further comprising a power source coupled to the sound generation circuitry.

16. The apparatus of claim 11 wherein the sound generation circuitry includes:
a memory;
a speaker coupled to the memory;
a switch; and
control circuitry coupled to the switch and the memory.

17. The apparatus of claim 16 wherein a switch activator is coupled to the switch.

18. The apparatus of claim 17 wherein the switch activator is a button coupled to the utensil.

19. The apparatus of claim 18 wherein the memory is a non-volatile memory.

20. The apparatus of claim 11 wherein the figurine is an animal, a vehicle, or a cartoon character.

21. A utensil comprising:
a serving portion;
a figurine coupled to serving portion; and
sound generation circuitry at least partially encapsulated in the figurine, wherein the sound generation circuitry outputs sound corresponding to the figurine.
